(19) United States
(12) Patent Application Publication
(10) Pub. No.: US 2026/0135078 A1
(43) Pub. Date: May 14, 2026

(54) ROLLING APPARATUS FOR MANUFACTURING ELECTRODE PLATE

(71) Applicant: SAMSUNG SDI CO., LTD., Yongin-si (KR)

(72) Inventors: Misun LEE, Yongin-si (KR); Daesung RO, Yongin-si (KR)

(21) Appl. No.: 19/325,310

(22) Filed: Sep. 10, 2025

(30) Foreign Application Priority Data
Nov. 8, 2024 (KR) 10-2024-0158336

(51) Int. Cl. H01M 4/04

(52) U.S. Cl. CPC H01M 4/0435

(57) ABSTRACT

A rolling apparatus for manufacturing an electrode plate is disclosed, where the electrode plate includes a substrate and an active material layer on at least a portion of an outer surface of the substrate, and the rolling apparatus includes a pressurizing member including a first pressurizing portion configured to pressurize the active material layer and a second pressurizing portion located at each of opposite sides of the first pressurizing portion and configured to press a portion of the outer surface of the substrate where the active material layer is absent.

### CROSS-REFERENCE TO RELATED APPLICATION

The present application claims priority to and the benefit of Korean Patent Application No. 10-2024-0158336, filed on Nov. 8, 2024 in the Korean Intellectual Property Office, the entire disclosure of which is incorporated herein by reference.

### BACKGROUND

### 1. Field

Aspects of embodiments of the present disclosure relate to a rolling apparatus for manufacturing an electrode plate.

### 2. Description of the Related Art

In modern society, as portable devices, such as mobile phones, laptops, camcorders, and digital cameras are used in daily life, development of techniques related to mobile devices is becoming active. In addition, a rechargeable battery capable of charging and discharging is a measure to solve air pollution, such as from conventional gasoline vehicles using fossil fuels, and is used as a power source for electric vehicles (EVs), hybrid electric vehicles (HEVs), and plug-in hybrid electric vehicles (P-HEV), and thus a need for development of rechargeable batteries is increasing.

Currently commercially available rechargeable batteries include a nickel cadmium battery, a nickel hydrogen battery, a nickel zinc battery, and a lithium rechargeable battery, and, among them, the lithium rechargeable battery has little memory effect compared to nickel-based rechargeable batteries and is in the spotlight as it may be freely charged and discharged, has a very low self-discharge rate, and has high energy density.

The manufacturing process of such a lithium rechargeable battery may be divided into three steps of an electrode process, an assembly process, and a formation process. The electrode process may be divided into an active material mixing process, an electrode coating process, a rolling process, a slitting process, a winding process, or the like. Among these, the rolling process is a process of compressing the electrode substrate to a desired thickness by passing it between a pair of rolling rolls heated at a high temperature to reduce the thickness of the electrode substrate after the coating process is completed, thereby increasing the capacity density and increasing the adhesion between the electrode current collector and the electrode active material.

However, when rolling the electrode substrate, the pressure applied to the substrate may be insufficient due to a thickness difference between a coated region where an active material is coated and an uncoated part where an active material is not coated. In addition, wrinkles may occur in the substrate, or the coating of the active material layer may be broken or peeled off.

### SUMMARY

According to an aspect of embodiments of the present disclosure, a rolling apparatus for manufacturing an electrode plate is capable of preventing or substantially preventing non-uniformly pressurizing a coated region and an uncoated part.

However, aspects and technical problems to be solved by the present disclosure are not limited to the above, and other aspects and objects not mentioned herein will be understood from the following description by those skilled in the art.

According to one or more embodiments, a rolling apparatus for manufacturing an electrode plate is disclosed, where the electrode plate includes a substrate and an active material layer on at least a portion of an outer surface of the substrate, and the rolling apparatus includes a pressurizing member including a first pressurizing portion configured to pressurize the active material layer and a second pressurizing portion located at each of opposite sides of the first pressurizing portion and configured to press a portion of the outer surface of the substrate where the active material layer is absent.

The pressurizing member may further include a protection member including an elastically deformable material, and located on a circumferential surface of the second pressurizing portion.

The pressurizing member may further include a first heating member in the first pressurizing portion and configured to heat the first pressurizing portion by converting electrical energy into thermal energy.

The pressurizing member may further include a second heating member in the second pressurizing portion and configured to heat the second pressurizing portion by converting electrical energy into thermal energy.

The rolling apparatus may further include a pressure variable unit coupled to the pressurizing member and configured to vary a pressure at which the pressurizing member presses the electrode plate.

The pressure variable unit may include a frame member coupled to the pressurizing member, and a power generating member coupled to the frame member and configured to move the frame member such that the frame member is movable closer to or further away from the electrode plate.

The first pressurizing portion and the second pressurizing portion may be integrally formed.

Each of the first pressurizing portion and the second pressurizing portion may have a cylindrical shape.

According to one or more embodiments, a rolling apparatus for manufacturing an electrode plate is disclosed, where the electrode plate includes a substrate and an active material layer on at least a portion of an outer surface of the substrate, and the rolling apparatus includes a pressurizing member including a first pressurizing portion configured to pressurize the active material layer, a pressure variable unit coupled to the pressurizing member, and configured to vary a pressure at which the pressurizing member presses the electrode plate, and a pressurizing unit configured to pressurize a portion of the outer surface of the substrate where the active material layer is absent.

The pressurizing unit may include a pressurizing plate located adjacent to the pressurizing member, and arranged to correspond to a portion of the substrate where the active material layer is not coated, and at least one driving member coupled to the pressurizing plate, and configured to move the pressurizing plate such that the pressurizing plate is movable in a direction closer to or further away from the substrate.

The pressurizing member may further include a heating member in the first pressurizing portion, and configured to heat the first pressurizing portion by converting electrical energy into thermal energy.

The pressurizing member and the pressurizing unit may be configured to concurrently pressurize the active material layer and pressurize the substrate.

According to embodiments of the present disclosure, a rolling apparatus for manufacturing an electrode plate can uniformly or substantially uniformly pressurize a substrate and an active material layer. Therefore, it is possible to prevent or substantially prevent wrinkles from occurring in the substrate, or coating of the active material layer from being broken or peeled off. Therefore, a manufacturing quality of the rechargeable battery can be improved.

### BRIEF DESCRIPTION OF THE DRAWINGS

The accompanying drawings illustrate some embodiments of the present disclosure and together with the disclosure herein, are provided for further understanding of the technical features of the present disclosure; however, the present disclosure is not to be construed as being limited to the drawings.

FIG. 1 is a perspective view showing a rechargeable battery according to an embodiment.

FIG. 2 is a cross-sectional view showing an electrode plate of an electrode assembly included in the rechargeable battery of FIG. 1.

FIG. 3 is a perspective view showing a rolling apparatus for manufacturing an electrode plate according to an embodiment of the present disclosure.

FIG. 4 is a cross-sectional view showing the rolling apparatus for manufacturing an electrode plate of FIG. 3.

FIG. 5 is a cross-sectional view showing a rolling apparatus for manufacturing an electrode plate that includes a pressurizing member according to an embodiment.

FIG. 6 is a cross-sectional view showing a rolling apparatus for manufacturing an electrode plate according to another embodiment of the present disclosure.

FIG. 7 is a perspective view showing a rolling apparatus for manufacturing an electrode plate according to another embodiment of the present disclosure.

FIG. 8 is a perspective view showing a rolling apparatus for manufacturing an electrode plate according to another embodiment of the present disclosure.

FIG. 9 is a cross-sectional view showing the rolling apparatus for manufacturing an electrode plate of FIG. 8.

FIG. 10 is a cross-sectional view showing a rolling apparatus for manufacturing an electrode plate according to another embodiment of the present disclosure.

### DESCRIPTION OF SYMBOLS

100, 200, 300, 400, 500: rolling apparatus for manufacturing electrode plate 110, 210, 310, 410, 510: pressurizing member

| | |
|---|---|
| 111: first pressurizing portion | 112: second pressurizing portion |
| 113: protection member | 131: first heating member |
| 132: second heating member | 140: first pressure variable unit |
| 141: power generating member | 142: frame member |
| 240: second pressure variable unit | 450: pressurizing unit |
| 451: driving member | 452: pressurizing plate |
| 530: third heating member | AM: active material layer |
| ST: substrate | |

### DETAILED DESCRIPTION

Herein, some embodiments of the present disclosure will be described in further detail with reference to the accompanying drawings. It is to be understood that terms and words used in the specification and the appended claims are not to be construed as having common and dictionary meanings, but are to be interpreted as having meanings and concepts corresponding to technical ideas of the present disclosure in view of the principle that the inventor can properly define the concepts of the terms and words in order to describe his/her own invention as best as possible. Therefore, embodiments disclosed in the present specification and the constructions depicted in the drawings are only some example embodiments of the present disclosure, and do not cover the entire scope of the present disclosure. Therefore, it is to be understood that there may be various equivalents and variations at the time of the application of this specification.

It is to be further understood that the terms “comprise” or “include” and/or “comprising” or “including,” when used in this specification, specify the presence of stated features, numbers, steps, operations, elements, and/or components, but do not preclude the presence or addition of one or more other features, numbers, steps, operations, elements, components, and/or groups thereof.

In addition, in order to help understanding of the present disclosure, the accompanying drawings may not be drawn to scale, and the dimensions of some components may be exaggerated. In addition, the same reference numerals may be assigned to the same elements in different embodiments.

When it is explained that two objects are “the same” or “identical,” this means that these objects may be substantially the same or substantially identical. Accordingly, the substantially same or substantially identical objects may include deviations considered low in the art, for example, deviations within 5%. In addition, when it is explained that certain parameters are uniform in a predetermined region, this may mean that the parameters are uniform in terms of an average in the corresponding region.

Although the terms “first,” “second,” and the like may be used to describe various elements, these elements are not limited by these terms. These terms are used to distinguish one element from another, and, unless stated to the contrary, a first element may be a second element.

Throughout the specification, unless stated otherwise, each element may be singular or plural.

When an element is “above (or under)” or “on (or below)” another element, the element can be on an upper surface (or a lower surface) of the other element, and one or more intervening elements may be present between the element and the other element on (or below) the element.

In addition, when an element is referred to as being “connected,” “coupled,” or “linked” to another element, the element may be directly connected or coupled to the other element, or one or more intervening elements may be present between each element, or each element may be “connected,” “coupled,” or “linked” to each other through one or more other elements.

A term “and/or” used herein includes any one or all combinations of the associated listed items. In addition, the use of “may” when describing the embodiments of the present disclosure relates to “one or more embodiments of the present disclosure.” Expressions such as “one or more” and “one or more” preceding a list of elements may modify the entire list of elements and may not modify individual elements of the list.

Throughout the specification, when referring to “A and/or B,” it indicates A, B, or A and B, unless specifically stated to the contrary, and, when referring to “C to D,” it indicates C or higher and D or lower, unless specifically stated to the contrary.

A phrase may refer to any and all suitable combinations when the phrase such as “at least one of A, B and C,” “at least one of A, B or C,” “at least one selected from the group A, B and C,” or “at least one selected from A, B and C” is used to specify a list of the elements A, B, and C.

A term “use” may be considered synonymous with a term “utilize.” As used herein, a term “substantially,” “about,” or a similar term may be used as a term of approximation rather than a term of degree, and used to consider an inherent variation in a measured or calculated value which is to be recognized by those skilled in the art.

In this specification, although the terms “first,” “second,” “third,” etc. may be used to describe various elements, components, regions, layers, and/or sections, these elements, components, regions, layers, and/or sections are not to be limited by these terms. These terms may be used to distinguish one element, component, region, layer, or cross section from another element, component, region, layer, or cross section. Accordingly, a first element, component, region, layer, or section discussed below may be named a second element, component, region, layer, or section without departing from the teachings of the embodiments.

For ease of explanation, a spatially relative term such as “beneath,” “below,” “lower,” “above,” “upper,” or the like may be used herein in order to describe a relationship between one element or feature and another element(s) or feature(s), as shown in the drawings. A spatially relative position is to be understood to encompass different directions of a device in use or operation in addition to directions shown in the drawings. For example, when the device in the drawing is turned over, an element described as “below” or “bottom” another element may be understood to be “above” or “above” another element. Therefore, the term “below” may encompass both upward and downward directions.

The terms used herein are intended to describe the embodiments of the present disclosure and are not intended to limit the present disclosure.

Before describing a rolling apparatus for manufacturing an electrode plate according to an embodiment, a rechargeable battery that can be manufactured by using a rolling apparatus for manufacturing an electrode plate according to an embodiment will be described.

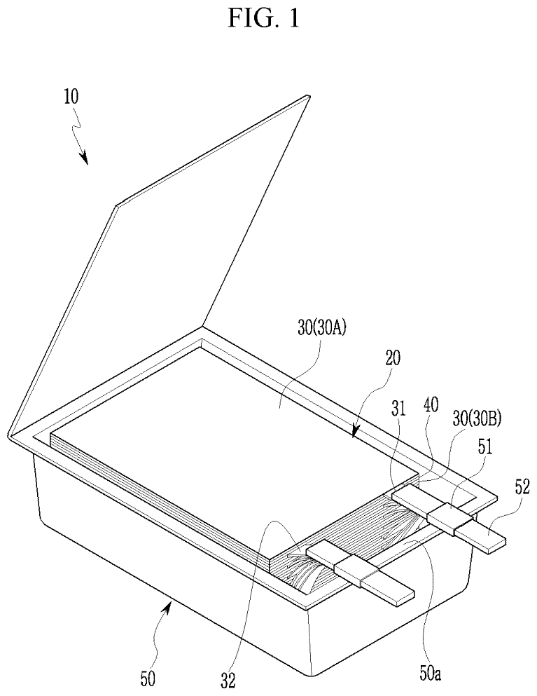

FIG. 1 is a perspective view showing a rechargeable battery according to an embodiment.

Referring to FIG. 1, a rechargeable battery 10 may include an electrode assembly 20 and a case 50.

The electrode assembly 20 may include a plurality of electrode plates 30 and a separator 40. In further detail, the plurality of electrode plates 30 may include a first electrode plate 30A and a second electrode plate 30B.

The electrode assembly 20 may be in a form in which a laminate including the first electrode plate 30A, the second electrode plate 30B, and the separator 40 is repeatedly wound or stacked.

In an embodiment, for example, the electrode assembly 20 may be a stacked type in which the electrode plates 30A and 30B are disposed to be stacked in a plurality of layers. In another embodiment, the electrode assembly 20 may be a jelly-roll type that is repeatedly wound. In the present disclosure, the electrode assembly 20 of the stacked type will be described as an example.

A manufacturing process of the electrode assembly 20 of the stacked type generally includes a primary stacking process and a secondary stacking process.

In the primary stacking process, full cathodes and full anodes may be stacked. Here, the full cathode may indicate remainders excluding first electrode plates 30A from a plurality of first electrode plates 30A. In addition, the full anode may be the second electrode plate 30B.

In the secondary stacking process, a half cathode may be stacked on one side of at least one of outermost both, or opposite, sides, based on a stacking direction. Here, the half cathode may be an outermost first electrode plate 30A among the first electrode plates 30A.

FIG. 1 illustrates an example of the electrode assembly 20 in which the half cathode is stacked on an outermost upper side of the electrode assembly 20; however, it may be possible that the half cathode is stacked on each of an outermost upper side and outermost both, or opposite, sides of the electrode assembly 20.

Here, the full cathode and the full anode are ones in which the active material layer is applied to both, or opposite, surfaces of a substrate, and the half cathode is one in which the active material layer is located on only one surface of the substrate. A further detailed description of the full cathode, the full anode, and the half cathode is not included herein.

The separator 40 may be interposed between the first electrode plate 30A and the second electrode plate 30B. The separator 40 prevents or substantially prevents a short circuit between the first electrode plate 30A and the second electrode plate 30B, and enables the movement of lithium ions. In an embodiment, the separator 40 may be formed in a size relatively greater than the first electrode plate 30A and the second electrode plate 30B.

The separator 40 may include a porous polymer film or a porous non-woven fabric. In an embodiment, the porous polymer film may be configured in a single layer or multiple layers including a polyolefin-based polymer, such as any of ethylene polymer, propylene polymer, ethylene/butene copolymer, ethylene/hexene copolymer, and ethylene/methacrylate copolymer. The porous non-woven fabric may include glass fiber of a high melting point, and polyethylene terephthalate fiber. However, the present disclosure is not limited thereto, and, depending on an embodiment, the separator may be a high heat-resistive separator containing ceramic (e.g., ceramic coated separator (CCS)).

In an embodiment, the separator 40 may be cut into unit lengths and disposed between the first electrode plate 30A and the second electrode plate 30B, or one separator 40 in a ribbon shape may be disposed in a zigzag form between the first electrode plate 30A and the second electrode plate 30B. In another embodiment, the separator 40 may be installed to be wound along a first direction between the first electrode plate 30A and the second electrode plate 30B.

As such, an arrangement form of the separator 40 is not limited to a particular form, but in the present embodiment, the separator 40 is cut into unit lengths and disposed between the first electrode plate 30A and the second electrode plate 30B.

The case 50 may accommodate the electrode assembly 20. The electrode assembly 20 described above may be accommodated in the case 50 together with an electrolyte.

In an embodiment, the electrolyte may be a non-aqueous electrolyte. The electrolyte may include a lithium salt and an organic solvent. The organic solvent may include one or more selected from the group consisting of propylene carbonate (PC), ethylene carbonate (EC), diethyl carbonate (DEC), dimethyl carbonate (DMC), ethylmethyl carbonate (EMC), methylpropyl carbonate (MPC), dipropyl carbonate (DPC), vinylene carbonate (VC), dimethyl sulfoxide, acetonitrile, dimethoxyethane, diethoxyethane, sulfolane, gamma-butyrolactone, propylene sulfide, and tetrahydrofuran.

The case 50 may be any of a pouch type, a cylindrical type, and a prismatic type. The case 50 of a pouch type may be manufactured by bending an exterior material of a plate shape, and then pressing or drawing a surface, to have a recess on the surface.

The electrode assembly 20 may be accommodated in the recess (not shown). A sealing portion 50a may be provided on an exterior circumference of the recess, and while the electrode assembly 20 is accommodated in the recess, the sealing portion 50a may be sealed through a method such as heat fusion.

In the plurality of electrode plates, the first electrode plate 30A described above may be a negative electrode, and the second electrode plate 30B may be a positive electrode, or vice versa. The first electrode plate 30A may include a first substrate tab 31 extending to the outside, and the second electrode plate 30B may include a second substrate tab 32 extending to the outside.

The first substrate tab 31 may be generated by cutting a collector layer (not shown) of the first electrode plate 30A by using a rolling apparatus for manufacturing an electrode plate, and the second substrate tab 32 may be generated by cutting a collector layer (not shown) of the second electrode plate 30B by using a rolling apparatus for manufacturing an electrode plate.

The first substrate tab 31 and the second substrate tab 32 may be electrically connected to the outside of the rechargeable battery 10 through a strip terminal 52. In an embodiment, an insulation tape 51 may be attached to a portion in the strip terminal 52 in contact with the case 50. The insulation tape 51 may prevent or substantially prevent the strip terminal 52 and the case 50 from being electrically conductive.

However, the rechargeable battery 10 that can be manufactured by using a rolling apparatus for manufacturing an electrode plate according to an embodiment is not necessarily limited to the above structure.

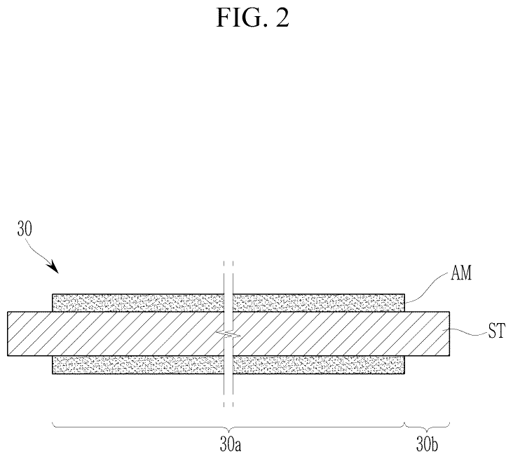

FIG. 2 is a cross-sectional view showing an electrode plate of an electrode assembly included in the rechargeable battery of FIG. 1.

Referring to FIG. 2, the electrode plate 30 may include a substrate ST and an active material layer AM on at least a portion of an outer surface of the electrode plate 30. In a manufacturing process of the electrode plate 30, the active material layer AM may be generated by applying a slurry on the electrode plate 30 and drying the slurry.

The substrate ST may be a current collector, and the current collector may include any suitable conductive material to the extent that it does not cause a chemical reaction within the rechargeable battery. For example, current collector may include any of stainless steel, nickel (Ni), aluminum (Al), titanium (Ti), copper (Cu), and an alloy thereof, and may be provided in various forms, such as a film, a sheet, a foil, or the like.

When the electrode plate 30 is divided into regions, the electrode plate 30 may be divided into a coated region 30a and an uncoated part 30b.

The coated region 30a may be a region coated with the active material layer AM in the electrode plate 30. The active material layer AM may be applied to a remaining portion excluding an edge region of the substrate ST. The edge region of the substrate ST may be the uncoated part 30b where the active material layer AM is not applied.

The active material layer AM may be located on a part of at least one surface of the substrate ST. An edge of the active material layer AM may be located to be spaced apart from an edge of the electrode plate 30. In an embodiment, a protection film (not shown) may be attached to a boundary portion between the active material layer AM and the electrode plate 30.

A method for locating the active material layer AM on the electrode plate 30 may be, for example, a method using a slit coater, but is not limited thereto, and any of various slurry (active material) coating methods may be used. The slurry discharged by the slit coater may be magnetized by a magnetizing device and then dried. The manufacturing process of the electrode plate 30 will be described further later.

In an embodiment, the active material layer AM may further include a binder (not shown) and a conductive material (not shown).

The binder (not shown) can mediate bonding between the electrode plate 30 and the active material, thereby improving mechanical stability. For example, the binder may be an organic binder or an aqueous binder, and may be used together with a thickener such as carboxymethyl cellulose (CMC).

In an embodiment, the organic binder may be any of vinylidene fluoride-hexafluoropropylene copolymer (PVDF-co-HFP), polyvinylidene fluoride (PVDF), polyacrylonitrile, and polymethylmethacrylate, and the aqueous binder may be a styrene-butadiene rubber (SBR), but the present disclosure is not limited thereto.

The conductive material (not shown) may improve the electrical conductivity of the rechargeable battery. In an embodiment, the conductive material may include a metal-based material. For example, the conductive material may include a typical carbon-based conductive material. In an embodiment, the conductive material may include one of graphite, carbon black, graphene, and carbon nanotube. In an embodiment, the conductive material may include carbon nanotube, but is not limited thereto.

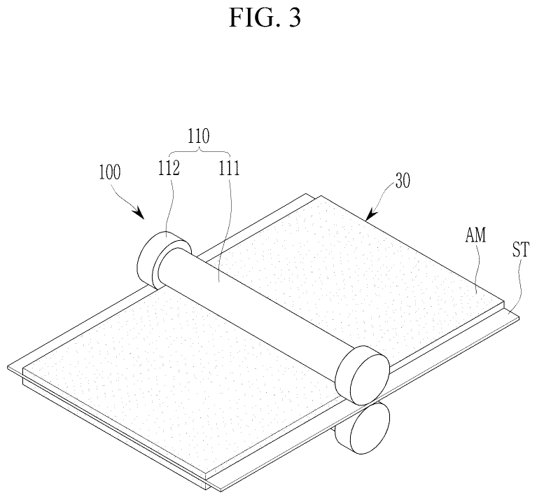

Herein, a rolling apparatus 100 for manufacturing the electrode plate (see FIG. 3) according to an embodiment used for manufacturing the electrode plate 30 will be described in further detail with reference to the drawings.

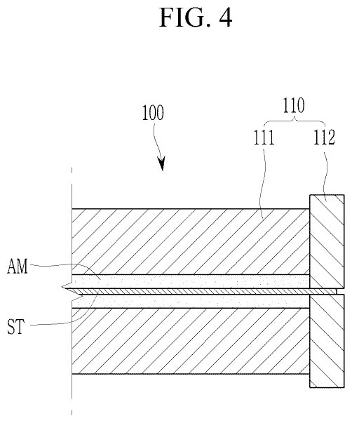

FIG. 3 is a perspective view showing a rolling apparatus for manufacturing an electrode plate according to an embodiment of the present disclosure; and FIG. 4 is a cross-sectional view showing the rolling apparatus for manufacturing an electrode plate of FIG. 3.

Referring to FIG. 3 and FIG. 4, the rolling apparatus 100 for manufacturing an electrode plate according to an embodiment of the present disclosure may include a pressurizing member 110.

The pressurizing member 110 may pressurize the electrode plate 30. The pressurizing member 110 may include a first pressurizing portion 111 and a second pressurizing portion 112.

The first pressurizing portion 111 may pressurize the active material layer AM. A width of the first pressurizing portion 111 may have a size corresponding to a width of the active material layer AM.

The second pressurizing portion 112 may be located on each of both, or opposite, sides of the first pressurizing portion 111, and may pressurize a portion of the substrate ST where the active material layer AM is not coated.

In an embodiment, the first pressurizing portion 111 and the second pressurizing portion 112 may be integrally formed. In an embodiment, each of the first pressurizing portion 111 and the second pressurizing portion 112 may have a cylindrical shape.

A diameter of the second pressurizing portion 112 may be relatively greater than a diameter of the first pressurizing portion 111. In an embodiment, a difference between the diameter of the second pressurizing portion 112 and the diameter of the first pressurizing portion 111 may be twice the thickness of the active material layer AM. Accordingly, while the first pressurizing portion 111 pressurizes the coated region 30a (see FIG. 2), the second pressurizing portion 112 may pressurize the uncoated part 30b (see FIG. 2).

The rolling apparatus 100 for manufacturing the electrode plate according to an embodiment of the present disclosure may uniformly or substantially uniformly pressurize the substrate ST and the active material layer AM by using the pressurizing member 110. Therefore, it is possible to prevent or substantially prevent wrinkles from occurring in the substrate ST, or coating of the active material layer AM from being broken or peeled off. Therefore, a manufacturing quality of the rechargeable battery may be improved.

The electrode plate 30 may be transported by a transporting device (not shown). The transporting device (not shown) may be, for example, an apparatus configured to transport the electrode plate 30 in a roll-to-roll manner. The sheet-shaped electrode plate 30 may be unwound from an unwinder (not shown). In addition, the rolled electrode plate 30 may be wound on a rewinder (not shown).

In the transporting device (not shown), a pair of rollers disposed to be in contact with an upper surface and a lower surface of the electrode plate 30 may be located at each particular location along a transport direction of the electrode plate 30. That is, a metal foil that can be used as the substrate ST of the electrode plate 30 of the rechargeable battery may be transported in the first direction, by being in contact with a plurality of rollers. The location of the rollers is not limited to a particular location.

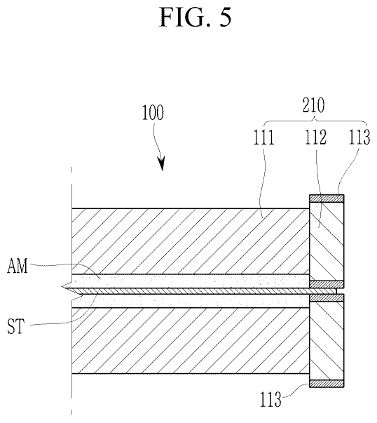

FIG. 5 is a cross-sectional view showing a rolling apparatus for manufacturing an electrode plate that includes a pressurizing member according to an embodiment.

Referring to FIG. 5, a pressurizing member 210 may further include a protection member 113.

The protection member 113 may be formed of an elastically deformable material, and may be located on a circumferential surface of the second pressurizing portion 112. In an embodiment, the protection member 113 may be formed of one selected from among, for example, silicone and fluorine.

The protection member 113 may prevent or substantially prevent damage of the substrate ST due to foreign substances possibly remaining on a surface of the second pressurizing portion 112.

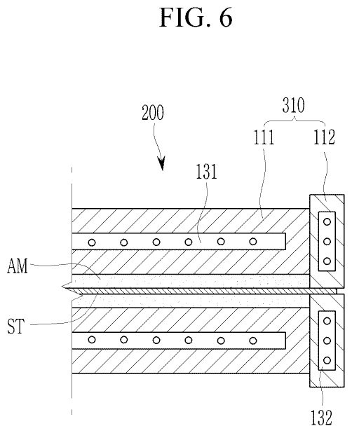

FIG. 6 is a cross-sectional view showing a rolling apparatus for manufacturing an electrode plate according to another embodiment of the present disclosure.

Referring to FIG. 6, a pressurizing member 310 included in a rolling apparatus 200 for manufacturing an electrode plate according to another embodiment of the present disclosure may further include a first heating member 131.

The first heating member 131 may be installed inside the first pressurizing portion 111, and may heat the first pressurizing portion 111 by converting electrical energy into thermal energy. Accordingly, the first pressurizing portion 111 may heat the active material layer AM at a different temperature from the second pressurizing portion 112.

The temperature at which the first pressurizing portion 111 is heated by the first heating member 131 may be in a range of, for example, room temperature or more and 200 degrees or less. Accordingly, during the process of rolling the electrode plate 30, the active material layer AM may be maintained at a target temperature by the heated first pressurizing portion 111.

In an embodiment, the pressurizing member 310 may further include a second heating member 132.

The second heating member 132 may be installed inside the second pressurizing portion 112, and may heat the second pressurizing portion 112 by converting electrical energy into thermal energy. Accordingly, the second pressurizing portion 112 may heat the substrate ST at a different temperature from the first pressurizing portion 111.

The temperature at which the second pressurizing portion 112 is heated by the second heating member 132 may be in a range of, for example, room temperature or more and 100 degrees or less. Accordingly, the substrate ST may be maintained at a target temperature by the heated second pressurizing portion 112.

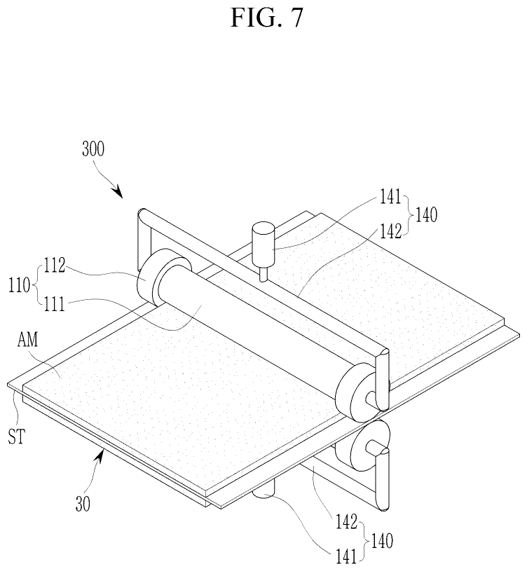

FIG. 7 is a perspective view showing a rolling apparatus for manufacturing an electrode plate according to another embodiment of the present disclosure.

Referring to FIG. 7, a rolling apparatus 300 for manufacturing an electrode plate according to another embodiment of the present disclosure may further include a first pressure variable unit 140.

The first pressure variable unit 140 may be coupled to the pressurizing member 110, and may vary a pressure at which the pressurizing member 110 presses the electrode plate 30. The first pressure variable unit 140 may include, for example, a frame member 142 and a power generating member 141.

The frame member 142 may be coupled to the pressurizing member 110. The frame member 142 may be coupled to both, or opposite, sides of the pressurizing member 110. The pressurizing member 110 may be rotatably coupled to the frame member 142.

The power generating member 141 may be coupled to the frame member 142. The power generating member 141 may move the frame member 142 such that the frame member 142 may become closer to or further away from the electrode plate 30. The power generating member 141 may include, for example, any selected from among a hydraulic cylinder, a pneumatic cylinder, rack and pinion gears, and a linear motor, but is not limited thereto.

As the frame member 142 is moved by the power generating member 141, the pressure at which the pressurizing member 110 presses the electrode plate 30 may be varied. Accordingly, the substrate ST and the active material layer AM of the electrode plate 30 may be pressurized at a target pressure.

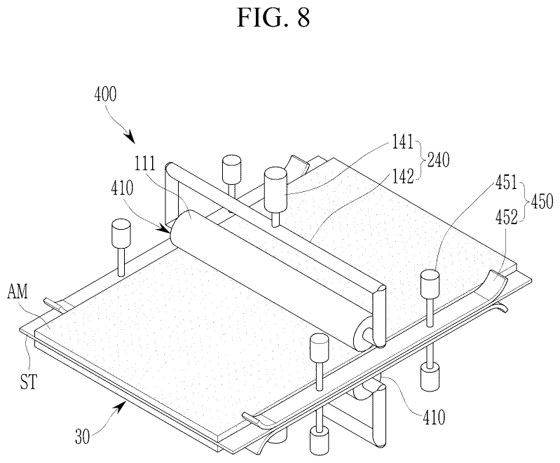

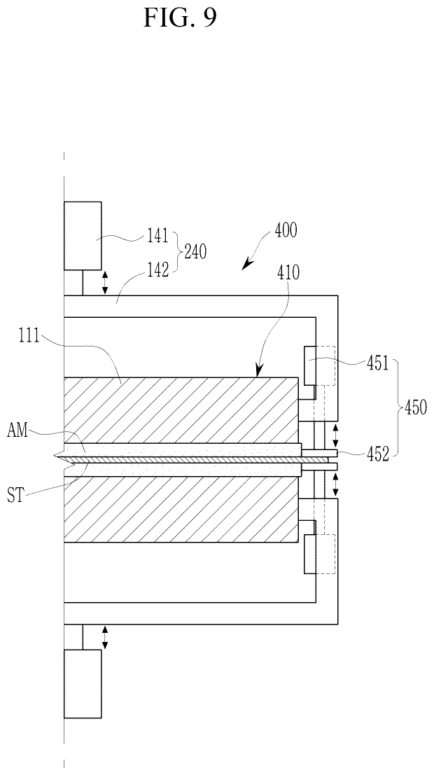

FIG. 8 is a perspective view showing a rolling apparatus for manufacturing an electrode plate according to another embodiment of the present disclosure; and FIG. 9 is a cross-sectional view showing the rolling apparatus for manufacturing an electrode plate of FIG. 8.

Referring to FIG. 8 and FIG. 9, a rolling apparatus 400 for manufacturing an electrode plate according to another embodiment of the present disclosure may include a pressurizing member 410, a second pressure variable unit 240, and a pressurizing unit 450.

The pressurizing member 410 may include the first pressurizing portion 111 configured to pressurize the active material layer AM. Unlike the pressurizing member 110 (see FIG. 3) included in the rolling apparatus 100 for manufacturing the electrode plate (see FIG. 3) according to the embodiment described above, the pressurizing member 410 does not include the second pressurizing portion 112 (see FIG. 3), and may only pressurize the active material layer AM.

The second pressure variable unit 240 may be coupled to the pressurizing member 410, and may vary a pressure at which the pressurizing member 410 presses the electrode plate 30.

The pressurizing unit 450 may pressurize a portion of the substrate ST where the active material layer AM is not coated. The pressurizing unit 450 for such a purpose may include, for example, a pressurizing plate 452 and at least one driving member 451.

The pressurizing plate 452 may be located adjacent to the pressurizing member 410, and may be formed to correspond to a portion of the substrate ST where the active material layer AM is not coated.

The driving member 451 may be coupled to the pressurizing plate 452, and may move the pressurizing plate 452 such that the pressurizing plate 452 may move in a direction closer to or further away from the substrate ST. The driving member 451 may be provided in plural. For example, two driving members 451 may be provided. The driving members 451 may be coupled to each of both, or opposite, sides of the pressurizing plate 452.

The driving member 451 may move the pressurizing plate 452, and the pressurizing plate 452 may stably pressurize the uncoated part 30b (see FIG. 2) of the electrode plate 30.

A rolling apparatus for manufacturing an electrode plate 400 according to the present embodiment of the present disclosure as described above includes the second pressure variable unit 240 and the pressurizing unit 450, and can pressurize the active material layer AM and the substrate ST while variably changing the pressure to be appropriate for each of the electrode plates 30 in various specifications.

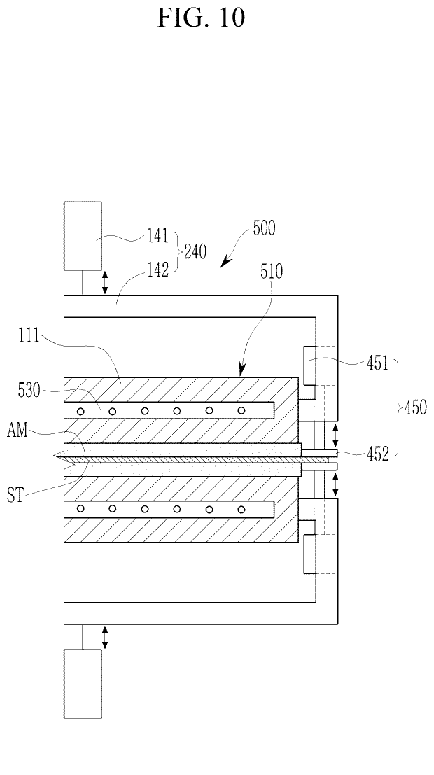

FIG. 10 is a cross-sectional view showing a rolling apparatus for manufacturing an electrode plate according to another embodiment of the present disclosure.

Referring to FIG. 10, the pressurizing member 510 included in a rolling apparatus 500 for manufacturing an electrode plate according to another embodiment of the present disclosure may further include a third heating member 530.

The third heating member 530 may be installed inside the first pressurizing portion 111, and may heat the first pressurizing portion 111 by converting electrical energy into thermal energy. The temperature at which the first pressurizing portion 111 is heated by the third heating member 530 may be in a range of, for example, room temperature or more and 100 degrees or less. Accordingly, during the process of rolling the electrode plate 30, the active material layer AM may be maintained at a target temperature by the heat of the first pressurizing portion 111.

In an embodiment, the pressurizing of the active material layer AM by the pressurizing member 110 and the pressurizing of the substrate ST by the pressurizing unit 450 may be concurrently (e.g., simultaneously) performed. Accordingly, since the active material layer AM and the substrate ST are concurrently (e.g., simultaneously) pressurized at a target pressure during the process of transporting the electrode plate 30, it is possible to prevent or substantially prevent wrinkles from occurring in the substrate ST, and the coating of the active material layer from being broken or peeled off.

In addition, although a conventional rolling apparatus pressurizes only the active material layer AM in the electrode plate 30 at a fixed pressure, the rolling apparatus 100 for manufacturing the electrode plate according to the present disclosure includes the second pressure variable unit 240 and the pressurizing unit 450, thereby being capable of pressurizing each of the active material layer AM and the substrate ST at an optimal pressure.

While the present disclosure has been described in connection with what are presently considered to be some practical embodiments, the drawings and the detailed description of the present disclosure which are described above are merely illustrative, are used for the purpose of describing the present disclosure, and are not intended to limit the meaning or limit the scope of the present disclosure, which is disclosed in the claims. Therefore, it is to be understood by those skilled in the art that various modifications and other equivalent embodiments may be made from the present disclosure. Accordingly, a protection scope of the present disclosure is to be defined by the claims.

What is claimed is:

1. A rolling apparatus for manufacturing an electrode plate, the electrode plate comprising a substrate and an active material layer on at least a portion of an outer surface of the substrate, the rolling apparatus being configured to pressurize the electrode plate and comprising:
a pressurizing member comprising a first pressurizing portion configured to pressurize the active material layer and a second pressurizing portion located at each of opposite sides of the first pressurizing portion and configured to press a portion of the outer surface of the substrate where the active material layer is absent.

2. The rolling apparatus as claimed in claim 1, wherein the pressurizing member further comprises a protection member comprising an elastically deformable material and located on a circumferential surface of the second pressurizing portion.

3. The rolling apparatus as claimed in claim 1, wherein the pressurizing member further comprises a first heating member in the first pressurizing portion and configured to heat the first pressurizing portion by converting electrical energy into thermal energy.

4. The rolling apparatus as claimed in claim 1, wherein the pressurizing member further comprises a second heating member in the second pressurizing portion and configured to heat the second pressurizing portion by converting electrical energy into thermal energy.

5. The rolling apparatus as claimed in claim 1, further comprising a pressure variable unit coupled to the pressurizing member and configured to vary a pressure at which the pressurizing member presses the electrode plate.

6. The rolling apparatus as claimed in claim 5, wherein the pressure variable unit comprises:
a frame member coupled to the pressurizing member; and
a power generating member coupled to the frame member and configured to move the frame member such that the frame member is movable closer to or further away from the electrode plate.

7. The rolling apparatus as claimed in claim 1, wherein the first pressurizing portion and the second pressurizing portion are integrally formed.

8. The rolling apparatus as claimed in claim 1, wherein each of the first pressurizing portion and the second pressurizing portion has a cylindrical shape.

9. A rolling apparatus for manufacturing an electrode plate, the electrode plate comprising a substrate and an active material layer on at least a portion of an outer surface of the substrate, the rolling apparatus being configured to pressurize the electrode plate and comprising:
a pressurizing member comprising a first pressurizing portion configured to pressurize the active material layer;
a pressure variable unit coupled to the pressurizing member, and configured to vary a pressure at which the pressurizing member presses the electrode plate; and
a pressurizing unit configured to pressurize a portion of the outer surface of the substrate where the active material layer is absent.

10. The rolling apparatus as claimed in claim 9, wherein the pressurizing unit comprises:
a pressurizing plate located adjacent to the pressurizing member, and arranged to correspond to a portion of the substrate where the active material layer is not coated; and
at least one driving member coupled to the pressurizing plate, and configured to move the pressurizing plate such that the pressurizing plate is movable in a direction closer to or further away from the substrate.

11. The rolling apparatus as claimed in claim 10, wherein the pressurizing member further comprises a heating member in the first pressurizing portion, and configured to heat the first pressurizing portion by converting electrical energy into thermal energy.

12. The rolling apparatus as claimed in claim 10, wherein the pressurizing member and the pressurizing unit are configured to concurrently pressurize the active material layer and pressurize the substrate.
